(19) United States
(12) Patent Application Publication
(10) Pub. No.: US 2019/0094251 A1
(43) Pub. Date: Mar. 28, 2019

(54) METHOD OF HANDLING A LABORATORY SAMPLE CONTAINER, LABORATORY APPARATUS AND LABORATORY AUTOMATION SYSTEM

(71) Applicant: Roche Diagnostics Operations, Inc., Indianapolis, IN (US)

(72) Inventor: Michal Malinowski, Bietigheim-Bissingen (DE)

(73) Assignee: Roche Diagnostics Operations, Inc., Indianapolis, IN (US)

(21) Appl. No.: 16/131,141

(22) Filed: Sep. 14, 2018

(30) Foreign Application Priority Data
Sep. 25, 2017 (EP) 17192956.5

(51) Int. Cl. G01N 35/04; G01N 35/00

(52) U.S. Cl. CPC G01N 35/04; G01N 35/00732; G01N 2035/0405; G01N 2035/0477; G01N 2035/0441; G01N 2035/00742

(57) ABSTRACT

A method of handling a laboratory sample container is presented. In addition, a laboratory apparatus and a laboratory automation system comprising such a laboratory apparatus are also presented.

### CROSS-REFERENCE TO RELATED APPLICATIONS

This application claims priority to EP 17192956.5, filed Sep. 25, 2017, which is hereby incorporated by reference.

### BACKGROUND

The present disclosure generally relates to a method of handling a laboratory sample container and to a laboratory apparatus and a laboratory automation system comprising such a laboratory apparatus.

Known laboratory automation systems typically comprise a number of laboratory stations. The laboratory stations may require laboratory sample containers such as sample tubes to be open for processing, in particular, analyzing, laboratory samples comprised by the laboratory sample containers. Furthermore, the laboratory automation systems typically comprise a laboratory sample distribution system in order to distribute or to move the laboratory samples comprised by the open laboratory sample containers between the number of laboratory stations.

However, there is a need for a method for handling a laboratory sample container in an improved manner over the prior art as well as a laboratory apparatus and a laboratory automation system comprising such a laboratory apparatus.

### SUMMARY

According to the present disclosure, a method of handling a laboratory sample container is presented. The method can comprise ensuring that an opening of the laboratory sample container is open and attaching a prolongation to the laboratory sample container such that the prolongation surrounds the opening of the laboratory sample container and protrudes the opening and such that a laboratory sample comprised by the open laboratory sample container is retained by the attached prolongation.

Accordingly, it is a feature of the embodiments of the present disclosure to provide for a method for handling a laboratory sample container in an improved manner over the prior art as well as to provide a laboratory apparatus and a laboratory automation system comprising such a laboratory apparatus. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a flow chart of a method according to an embodiment of the present disclosure.

FIG. 2 illustrates a laboratory sample container with a closed opening according to an embodiment of the present disclosure.

FIG. 3 illustrates a laboratory apparatus comprising an ensurer according to an embodiment of the present disclosure.

FIG. 4 illustrates the laboratory apparatus of FIG. 3 comprising the ensurer ensuring that the opening of the laboratory sample container of FIG. 2 is open according to an embodiment of the present disclosure.

FIG. 5 illustrates the laboratory sample container of FIG. 2 with the opening being open according to an embodiment of the present disclosure.

FIG. 6 illustrates a side view of the laboratory apparatus comprising an attacher attaching a prolongation to the laboratory sample container of FIG. 2 according to an embodiment of the present disclosure.

FIG. 7 illustrates a top view of the laboratory apparatus and the attacher of FIG. 6 according to an embodiment of the present disclosure.

FIG. 8 illustrates the open laboratory sample container of FIG. 2 with the attached prolongation carried by a sample container carrier according to an embodiment of the present disclosure.

FIG. 9 illustrates the laboratory apparatus comprising a sealer sealing the attached prolongation of FIG. 8 according to an embodiment of the present disclosure.

FIG. 10 illustrates a laboratory automation system comprising the laboratory apparatus, a laboratory sample distribution system comprising the sample container carrier of FIG. 8 and a plurality of laboratory stations according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A method of handling such as, for example, automatically handling, a laboratory sample container is presented. The method can comprise the steps: a) ensuring such as, for example, automatically ensuring, that an opening of the laboratory sample container is open and b) attaching such as, for example, automatically attaching, a prolongation to the laboratory sample container such that the prolongation can surround or encircle the opening of the laboratory sample container and protrude the opening such that a laboratory sample comprised or contained by the open laboratory sample container is retained or hold back by the attached prolongation.

The method or the attached prolongation, respectively, can enable the reduction or prevention of spilling of the laboratory sample, if present, comprised by the open laboratory sample container out of the laboratory sample container and the attached prolongation, in particular, during moving the open laboratory sample container by a laboratory sample distribution system. Thereby, contamination of the laboratory sample distribution system and/or other laboratory sample containers and/or other laboratory samples may be reduced or avoided. Furthermore, the method or the attached prolongation, respectively, can still enable a relatively easy access to the laboratory sample comprised by the open laboratory sample container such as, for example, for a plurality of laboratory stations.

The laboratory sample container may be designed as a tube made of glass or transparent plastic and may have the opening at an upper or top end.

Moreover, the laboratory sample container and its opening, respectively, may be closed by a cap or a closure. The cap may comprise rubber and/or plastic or may completely consist of rubber and/or plastic. In one embodiment, step a) may comprise opening the laboratory sample container, when the opening is closed such as, for example, by removing the cap, if present, from the laboratory sample container.

Additionally, or alternatively, step a) may comprise detecting or checking, respectively, whether the opening of the laboratory sample container is closed such as, for example, by the cap, or open and, when the opening is closed, opening the laboratory sample container such as, for example, by removing the cap, if present, from the laboratory sample container, or, when the opening is open, leaving the laboratory sample container open.

Further, additionally, or alternatively, step a) may comprise providing the laboratory sample container with its opening open. Additionally, the method may comprise the step of filling the laboratory sample into the, in particular, open, laboratory sample container.

Further, additionally, or alternatively, step b) may comprise connecting the prolongation to the laboratory sample container such as, for example, by a chemical bond, such as, for example, in between the prolongation and the laboratory sample container, for example by soldering and/or welding.

The prolongation may be denoted as an extension or a collar. The prolongation may be attached to or be in contact with the laboratory sample container at an outside surface in the region of the opening such as, for example, at a circumference of the laboratory sample container. The prolongation may completely surround the opening without a gap or an interruption such as, for example, along the circumference. In other words, the prolongation may comprise or have a form of a closed ring or tube with two open ends such as, for example, directly after the attachment of the prolongation. Protruding the opening of the laboratory sample container may be denoted as extending or prolonging the laboratory sample container. Additionally, or alternatively, a thickness such as, for example, a wall thickness, of the prolongation may be maximum of about 500 μm, in another embodiment, maximum of about 200 μm, in yet another embodiment, maximum of about 100 μm, and yet still another embodiment, maximum of about 50 μm.

Step b) may be performed simultaneously with step a) and/or after step a) and/or before step a).

The laboratory sample may be a blood sample, a urine sample or a chemical sample. In one embodiment, the laboratory sample may be a liquid. Additionally, or alternatively, the laboratory sample may only be comprised by the, in one embodiment, open, laboratory sample container, in one embodiment, when the laboratory sample container stands still or is not moved, respectively. In other words, the laboratory sample does not have to be or may not be comprised by the attached prolongation such as, for example, when the laboratory sample container stands still or is not moved. Formulated differently, a volume of the laboratory sample may be equal to or smaller than a volume such as, for example, an internal volume, of the laboratory sample container.

According to an embodiment, the attached prolongation can protrude the opening by a length of at least about 1 millimeter (mm) to about 20 mm, in another embodiment, of at least about 5 mm to about 15 mm, and in yet another embodiment, exactly 10 mm.

According to an embodiment, the prolongation can comprise a laboratory sample-repellent property such as, for example, at an inside of the prolongation and/or above the opening.

This can enable a relatively high reliability of the prolongation and/or can enable a relatively high retaining of the laboratory sample, if present. In one embodiment, the prolongation may comprise a liquid-tight property. The prolongation may comprise a barrier material such as, for example, coated aluminum foil (Alu/PE, Alu/PP), coated paper (PA/PE), a composite material according DIN 55 531 or TL 8135-0003 or TL 8135-0006 A/B, another material as oPP or a, in one embodiment, thermoplastic, foil (PE).

According to an embodiment, step b) can comprise adhering the prolongation to the laboratory sample container. In one embodiment, the prolongation may comprise an adhesive such as, for example, a pressure sensitive adhesive. The adhering may be denoted as sticking or gluing.

According to an embodiment, step b) can comprise forming the prolongation by rotating a prolongation blank with respect to the laboratory sample container around the laboratory sample container. In one embodiment, the forming of the prolongation may comprise rolling of the laboratory sample container on the prolongation blank. The rotating may be around a longitudinal axis of the laboratory sample container. The prolongation blank may be provided from a prolongation blank supply roll.

According to an embodiment, the laboratory sample container can comprise a from-the-outside optically readable tag. The method can comprise optically reading such as, for example, automatically reading, the tag during step b). Thereby, the rotating can have multiple uses. Typically, the tag may not surround the laboratory sample container completely such as, for example, not around the circumference of the laboratory sample container, but rather may be readable only from one side of the laboratory sample container. The rotating may enable the reading of the tag. In one embodiment, the tag may be an identification tag configured to enable identifying the laboratory sample, if present, comprised by the laboratory sample container. The tag may comprise or be a barcode.

According to an embodiment, the method can comprise the step: c) moving such as, for example, translationally moving and/or automatically moving, the open laboratory sample container with the attached prolongation by a laboratory sample distribution system.

According to an embodiment, the laboratory sample distribution system can comprise a sample container carrier, a transport plane and a plurality of drive elements (e.g., 1 to 10000). The sample container carrier can be configured to carry the laboratory sample container. The transport plane can be configured to support the sample container carrier. The plurality of drive elements can be configured to move the sample container carrier on the transport plane. Step c) can comprise moving the sample container carrier with the carried laboratory sample container on the transport plane by the plurality of drive elements.

The transport plane may comprise a step, a bump or a hole and/or have a different surface friction at different positions, which may have caused a spilling of the laboratory sample out of the open laboratory sample container without the attached prolongation during the moving. Additionally, or alternatively, the plurality of drive elements may accelerate or decelerate the laboratory sample container during the moving in a manner, which may have caused a spilling of the laboratory sample out of the open laboratory sample container without the attached prolongation.

The transport plane may also be denoted as transport surface. The transport plane may support the sample container carrier, what may also be denoted as carrying the sample container carrier. The sample container carrier may be translationally moved on the transport plane. The sample container carrier may be configured to move in two dimensions on the transport plane. The sample container carrier may slide over the transport plane. The sample container carrier may move on the transport plane along an individual transport path. In one embodiment, the laboratory sample distribution system may comprise a plurality of sample container carriers (e.g., 1 to 1000).

According to an embodiment, the plurality of drive elements can comprise a plurality of electro-magnetic actuators. The plurality of electro-magnetic actuators can be stationary arranged in a grid below the transport plane and can be configured to generate a magnetic field to move the sample container carrier on the transport plane. The sample container carrier can comprise a magnetically active element. The magnetically active element can be configured to interact with the magnetic field generated by the plurality of electro-magnetic actuators such that a move force such as, for example, a magnetic move force, can be applied to the sample container carrier. Step c) can comprise moving the sample container carrier by the plurality of electro-magnetic actuators.

The arrangement of the plurality of electro-magnetic actuators in the grid may accelerate or decelerate the laboratory sample container during the moving in a manner, which may have caused a spilling of the laboratory sample out of the open laboratory sample container without the attached prolongation.

The electro-magnetic actuators may be solenoids surrounding ferromagnetic cores. Furthermore, the electro-magnetic actuators may be driven or energized individually in order to generate or to provide the magnetic field. The electro-magnetic actuators may be arranged in two dimensions. The grid may have rows and columns, along which the electro-magnetic actuators can be arranged. The electro-magnetic actuators may be arranged in a plane substantially parallel to the transport plane. The magnetically active element may be a permanent magnet or an electro-magnet. The magnetically active element may comprise a magnetically soft material.

According to an embodiment, the method can comprise the step d) closing such as, for example, automatically closing, the opening of the laboratory sample container by sealing or shutting the attached prolongation such as, for example, above and/or beyond the opening. This may enable storage of the laboratory sample, if present, comprised by the laboratory sample container. Additionally, or alternatively, this may enable shipment of the laboratory sample, if present, comprised by the laboratory sample container. The attached prolongation may be pressed together. The prolongation may comprise an adhesive such as, for example, a pressure sensitive adhesive. In one embodiment, the prolongation may comprise a hot sealable property and may be sealed by heat treatment. The prolongation may comprise a hot sealable material such as for example, cellophane, BOPP, POP (Polyolefin Plastomere), PE-VLD (very low density), PE-LD (low density), PE-LLD (linear low density) and/or PE-HD (high density). A seal temperature of the prolongation may be in a range from about 30 degrees Celsius (° C.) to about 200° C., in another embodiment from about 60° C. to about 180° C., in yet another embodiment from about 90° C. to about 140° C., in still another embodiment from about 9520 C. to about 120° C., and in yet still another embodiment from about 10020 C. to about 110° C.

A laboratory apparatus is also presented. The laboratory apparatus can comprise an ensurer and an attacher. The ensurer can be configured to ensure that an opening of a laboratory sample container is open. The attacher can be configured to attach a prolongation to the laboratory sample container such that the prolongation can surround the opening of the laboratory sample container and protrude the opening. The laboratory apparatus can be configured such that a laboratory sample comprised by the open laboratory sample container can be retained by the attached prolongation.

The ensurer may comprise or be an opener configured to open the laboratory sample container when closed. In one embodiment, the ensurer may comprise or be a decapper configured to remove the cap, if present, from the laboratory sample container.

Additionally, or alternatively, the ensurer may comprise or be a detector such as, for example, a cap detector, configured to detect whether the opening of the laboratory sample container is closed such as, for example by the cap, or open. Additionally, the ensurer may comprise or be an opener such as, for example, a decapper, configured to open the laboratory sample container such as, for example, to remove the cap, if present, from the laboratory sample container when the opening is closed and/or to leave the laboratory sample container open when the opening is open.

Further, additionally, or alternatively, the ensurer may comprise or be provider configured to provide the laboratory sample container with its opening open. Additionally, the laboratory apparatus may comprise a filler configured to fill the laboratory sample into the, in particular, open, laboratory sample container.

Further, additionally, or alternatively, the attacher may comprise or be a connector configured to connect the prolongation to the laboratory sample container such as, for example, by a chemical bond, for example, in between the prolongation and the laboratory sample container. For example, the connector may comprise or be a solder device configured to solder and/or a welding device configured to weld.

According to an embodiment, the attacher can be configured to supply a prolongation blank to the laboratory sample container such that the prolongation can be formed by a rotation of the prolongation blank with respect to the laboratory sample container around the laboratory sample container. In one embodiment, the laboratory apparatus may comprise a rotator, wherein the rotator may be configured to rotate the prolongation blank and/or the laboratory sample container. Additionally, or alternatively, the laboratory apparatus and its attacher, respectively, may comprise a receptacle for a prolongation blank supply roll.

According to an embodiment, the laboratory apparatus can comprise an optical reader. The optical reader can be configured to optically read a from-the-outside optically readable tag comprised by the laboratory sample container during a rotation of the optical reader with respect to the laboratory sample container around the laboratory sample container. In one embodiment, the optical reader may comprise or be a camera and/or a barcode reader. Additionally, or alternatively, the laboratory apparatus may comprise a rotator, wherein the rotator may be configured to rotate the optical reader and/or the laboratory sample container.

According to an embodiment, the laboratory apparatus may comprise a sealer wherein the sealer may be configured to close the opening of the laboratory sample container by sealing the attached prolongation. In one embodiment, the sealer may comprise or be a heat sealer.

A laboratory automation system is also presented. The laboratory automation system can comprise a laboratory apparatus as described above and a laboratory sample distribution system. The laboratory sample distribution system can be configured to move the open laboratory sample container with the attached prolongation.

The laboratory sample distribution system may be embodied as described above. Additionally, the laboratory sample distribution system may comprise a control device. The control device may comprise or be an integrated circuit, a tablet computer, a smartphone or a computer. In one embodiment, the control device may be configured to control the plurality of drive elements, if present, such that the sample container carrier with the carried laboratory sample container can move on the transport plane by the plurality of drive elements. Furthermore, the control device may be configured to control the plurality of electro-magnetic actuators, if present, such that the sample container carrier with the carried laboratory sample container can move on the transport plane by the plurality of electro-magnetic actuators. The laboratory sample distribution system may comprise the plurality of sample container carriers. The control device may be configured to control the plurality of drive elements or the plurality of electro-magnetic actuators, if present, such that the plurality of sample container carriers moves on the transport plane along corresponding, in particular individual, transport paths simultaneously.

According to an embodiment, the laboratory automation system can comprise a plurality of laboratory stations. The laboratory sample distribution system can be configured to distribute or to move the laboratory sample container and/or the laboratory sample, if present, and/or the sample container carrier, if present, between the laboratory stations.

The laboratory stations may be arranged adjacent or directly next to the laboratory sample distribution system such as, for example, to the transport plane, if present, of the laboratory sample distribution system. The plurality of laboratory stations may comprise pre-analytical, analytical and/or post-analytical laboratory stations. Pre-analytical laboratory stations may be configured to perform any kind of pre-processing of laboratory samples, laboratory sample containers and/or sample container carriers. Analytical laboratory stations may be configured to use a laboratory sample or a part of the laboratory sample and a reagent to generate a measuring signal, the measuring signal indicating if and in which concentration, if any, an analyte exists. Post-analytical laboratory stations may be configured to perform any kind of post-processing of laboratory samples, laboratory sample containers and/or sample container carriers. The pre-analytical, analytical and/or post-analytical laboratory stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, a sealing/desealing station, a pushing station, a belt station, a conveying system station and/or a gripper station for moving the sample container to or from the sample container carrier.

The laboratory apparatus, the ensurer, the attacher, the optical reader, if present, the rotator, if present, and/or the sealer, if present, may be denoted as a laboratory station/s.

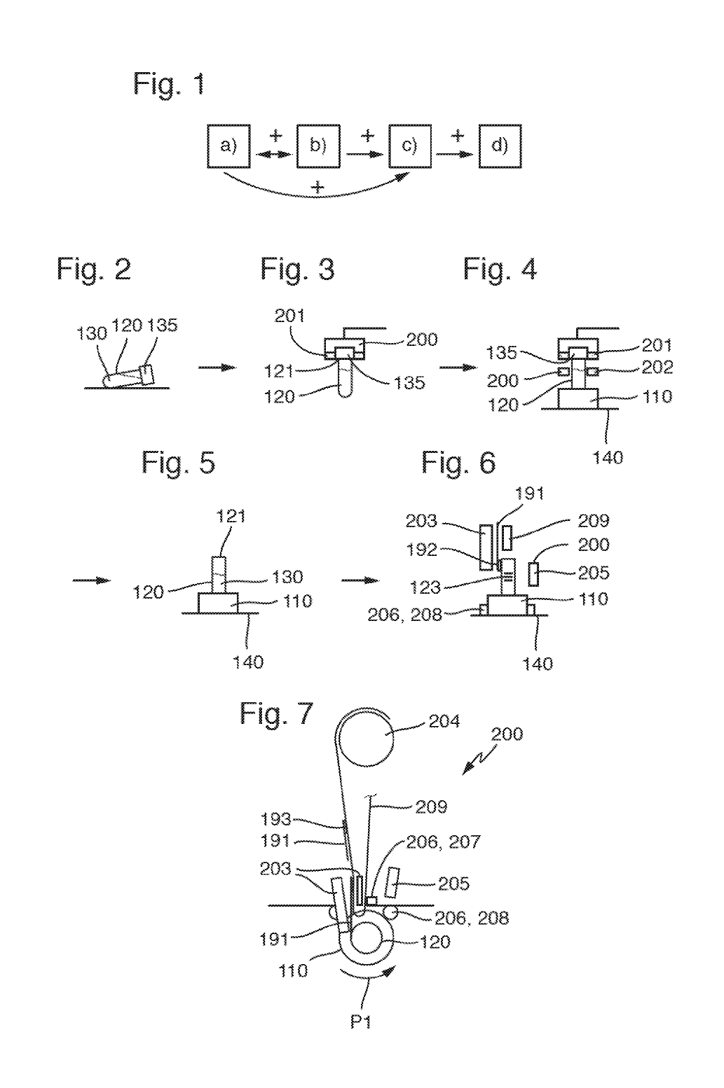

Referring initially to FIG. 1, FIG. 1 shows a method of handling a laboratory sample container 120, as shown in FIG. 2. The method can comprise a) ensuring that an opening 121 of the laboratory sample container 120 is open, as shown in FIGS. 3-5, and b) attaching a prolongation 190 to the laboratory sample container 120 such that the prolongation 190 surrounds the opening 121 of the laboratory sample container 120 and protrudes the opening 121, as shown in FIGS. 6-8 such that a laboratory sample 130 comprised by the open laboratory sample container 120 can be retained by the attached prolongation 190.

FIGS. 3-10 show a laboratory automation system 10 comprising a laboratory apparatus 200. The laboratory apparatus can comprise an ensurer 201, 202 and an attacher 203. The ensurer 201, 202 can be configured to ensure that the opening 121 of the laboratory sample container 120 is open. The attacher 203 can be configured to attach the prolongation 190 to the laboratory sample container 120 such that the prolongation 190 surrounds the opening 121 of the laboratory sample container 120 and protrudes the opening 121. The laboratory apparatus 200 can be configured such that the laboratory sample 130 comprised by the open laboratory sample container 120 can be retained by the attached prolongation 190.

In the shown embodiment, the laboratory sample container 120 can be designed as a tube and can have the opening 121 at such as, for example, an upper, end, as shown in FIG. 5. In FIGS. 2-4, the laboratory sample container 120 and its opening 121, respectively, can be closed by a cap 135. The laboratory sample container 120 can comprise the laboratory sample 130 in the form of a liquid.

In detail, the laboratory apparatus 200 and its ensurer 201, 202, respectively, can be configured to pick the laboratory sample container 120 up, as shown in FIG. 3. Furthermore, the laboratory apparatus 200 and its ensurer 201, 202, respectively, can be configured to align or orient the laboratory sample container 120 such as, for example, with its opening 121 up. This may be denoted as aligning the laboratory sample container 120.

The ensurer 201, 202 can be embodied as an opener configured to open the closed laboratory sample container 120 such as, for example, to remove the cap 135 from the laboratory sample container 120. In detail, the ensurer can comprise a first gripper 201 and a second gripper 202 different from the first gripper 201. The second gripper 202 can be configured to grip the laboratory sample container 120 such as, for example, at its circumference. The first gripper 201 can be configured to grip the cap 135 such as, for example, at its circumference. Moreover, the first gripper 201 and the second gripper 202 can be configured to remove the cap 135 from the laboratory sample container 120 by moving the cap 135 and the laboratory sample container 120 away from each other, as shown in FIG. 4.

Step a) can comprise opening the laboratory sample container 120 such as, for example, by the ensurer 201, 202 in the form of the opener.

Step b) can comprise adhering the prolongation 190 to the laboratory sample container 120 such as, for example, by the attacher 203.

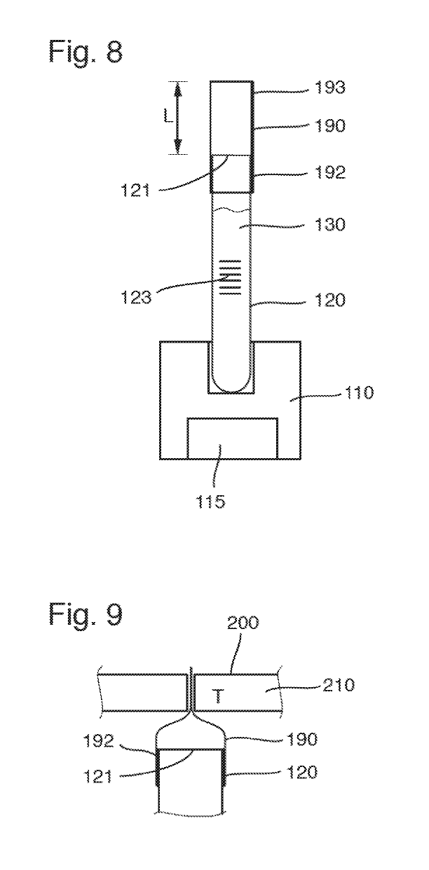

In detail, the prolongation 190 can comprise an adhesive or an adhesive layer or an adhesive strip 192, in one embodiment, at an, in FIG. 8, lower end of the prolongation 190. The prolongation 190 can be adhered to the laboratory sample container 120 by the adhesive 192.

Further, the attacher 203 can be configured to supply a prolongation blank 191 to the laboratory sample container 120 such that the prolongation 190 can be formed by a rotation of the prolongation blank 191 with respect to the laboratory sample container 120 around the laboratory sample container 120, as shown in FIGS. 6-7. In detail, the laboratory apparatus 200 can comprise a rotator 206. The rotator 206 can be configured to rotate the laboratory sample container 120 around a longitudinal axis of the laboratory sample container 120, as shown by arrow P1. Furthermore, the laboratory apparatus 200 and its attacher 203, respectively, can comprise a receptacle 204 for a prolongation blank supply roll. The prolongation blank 191 can be supplied or provided from a carrier band 209.

Step b) can comprise forming the prolongation 190 by rotating the prolongation blank 191 with respect to the laboratory sample container 120 around the laboratory sample container 120 such as, for example, by the attacher 203.

In detail, the prolongation blank 191 can have a substantially rectangular shape directly before the attachment. The prolongation blank 191 can comprise the adhesive 192 at its lower end or its lateral edge, as shown in FIG. 6. Additionally, the prolongation blank 191 can comprise an adhesive 193 at its back vertical edge, as shown in FIG. 7.

The prolongation blank 191 can be rolled to the prolongation 190 around the laboratory sample container 120. Thereby, the prolongation 190 can be adhered to the laboratory sample container 120 at an outside surface completely along or around a circumference of the opening 121 by the adhesive 192. Additionally, the prolongation 190 can be adhered to itself by the adhesive 193. The attached prolongation 190 can have a form of a closed ring and completely can surround the laboratory sample container 120 and its opening 121, respectively, without a gap.

The attached prolongation 190 can protrudes the opening 121 by a length L of about 20 mm, as shown in FIG. 8.

Furthermore, the prolongation 190 can comprise a laboratory sample-repellent property. In one embodiment, the prolongation 190 can comprise a liquid-tight barrier material.

Moreover, the laboratory sample container 120 can comprise a from-the-outside optically readable tag 123 in the form of a barcode, as shown in FIGS. 6 and 8.

The laboratory apparatus 200 can comprise an optical reader 205 in the form of a barcode reader. The optical reader 205 can be configured to optically read the from-the-outside optically readable tag 123 comprised by the laboratory sample container 120 during a rotation of the optical reader 205 with respect to the laboratory sample container 120 around the laboratory sample container 120.

The method can comprise optically reading the tag 123 during step b) such as, for example, by the optical reader 205.

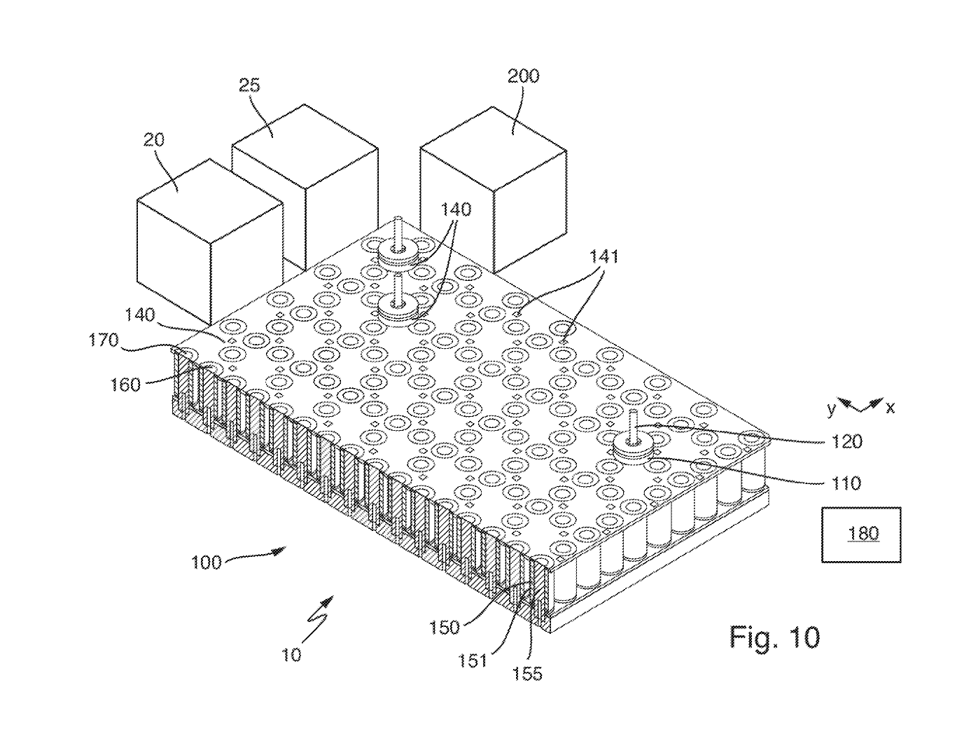

Further, the laboratory automation system 10 can comprise a laboratory sample distribution system 100, as shown in FIG. 10. The laboratory sample distribution system 100 can be configured to move the open laboratory sample container 120 with the attached prolongation 190.

The method can comprise moving the open laboratory sample container 120 with the attached prolongation 190 by the laboratory sample distribution system 100.

The attached prolongation can enable to the reduction or prevention of spilling of the laboratory sample 130 comprised by the open laboratory sample container 120 out of the laboratory sample container 120 and the attached prolongation 190.

In the shown embodiment, the laboratory sample distribution system can comprise a sample container carrier 110, a transport plane 140 and a plurality of drive elements 150. The sample container carrier 110 can be configured to carry the laboratory sample container 120. The transport plane 140 can be configured to support the sample container carrier 110. The plurality of drive elements 150 can be configured to move the sample container carrier 110 on the transport plane 140.

In detail, the sample container carrier 110 can be translationally moved in two dimensions x, y substantially perpendicular to each other on or over the transport plane 140. In the shown embodiment, a sliding surface of the sample container carrier 110 can be configured to be in contact with the transport plane 140 and can enable performing movements such as, for example, slides, of the sample container carrier 110 on the transport plane 150. In one embodiment, the laboratory sample distribution system 100 can comprise a plurality of sample container carriers 110. Self-evidently, more than the three sample container carriers 110 depicted in FIG. 10 may be comprised in the laboratory sample distribution system 100. Additionally, the laboratory sample distribution system 100 can comprise a control device 180. The control device 180 can be configured to control the plurality of drive elements 150 such that the sample container carrier 110 with the carried laboratory sample container 120 can move on the transport plane 140 by the plurality of drive elements 150. In one embodiment, the control device 180 can be configured to control the plurality of drive elements 150 such that the plurality of sample container carriers 110 can move on the transport plane 140 along corresponding transport paths such as, for example, each of the sample container carriers 110 along an individual transport path simultaneously.

Step c) can comprise moving the sample container carrier 110 with the carried laboratory sample container 120 on the transport plane 140 by the plurality of drive elements 150 such as, for example, along an individual transport path.

In detail, the plurality of drive elements 150 can comprise a plurality of electro-magnetic actuators 151. The plurality of electro-magnetic actuators 151 can be stationary arranged in a grid 160, 170 below the transport plane 140 and can be configured to generate a magnetic field to move the sample container carrier 110 on the transport plane 140. The sample container carrier 110 can comprise a magnetically active element 115 in the form of a permanent magnet, as shown in FIG. 8. The magnetically active element 115 can be configured to interact with the magnetic field generated by the plurality of electro-magnetic actuators 151 such that a move force can be applied to the sample container carrier 110.

Additionally, the control device 180 can be configured to control the plurality of electro-magnetic actuators 151 such that the sample container carrier 110 with the carried laboratory sample container 120 can move on the transport plane 140 by the plurality of electro-magnetic actuators 151 such as, for example, along an individual transport path.

Step c) can comprise moving the sample container carrier 110 by the plurality of electro-magnetic actuators 151 such as, for example, along an individual transport path.

In the shown embodiment, the electro-magnetic actuators 151 can be implemented as solenoids having a solid ferromagnetic core 155. The electro-magnetic actuators 151 can be quadratically arranged in the grid having rows 160 and columns 170 such as, for example, in a plane substantially parallel to the transport plane 140. In each center of a quadrat formed by corresponding electro-magnetic actuators 151, no electro-magnetic actuator can be arranged. In other words, in each second row and in each second position, there may be no electro-magnetic actuator 151. Additionally, the electro-magnetic actuators 151 can be driven individually such as, for example, by the control device 180, in order to generate the magnetic field.

Furthermore, the laboratory sample distribution system 100 can comprise a plurality of Hall-sensors 141. The plurality of Hall-sensors 141 can be arranged such that a position of a respective sample container carrier 110 on the transport plane 140 can be detected. The control device 180 can be functionally coupled to the Hall-sensors 141 for detecting the position of the sample container carrier 110. The control device 180 can be configured to control the electro-magnetic actuators 151 in response to the detected position.

In the shown embodiment, the laboratory apparatus 200 or its ensurer 201, 202, respectively, can be configured to insert the laboratory sample container 120 into the sample container carrier 110 such as, for example, on the transport plane 140, as shown in FIG. 4. Then, the laboratory sample distribution system 100 can move such as, for example, relatively slowly moves, the open laboratory sample container 120 from the ensurer 201, 202 to the attacher 203 such as, for example, by its sample container carrier 110, as shown in FIG. 5. In alternative embodiments, the laboratory apparatus may be embodied such that the open laboratory sample container carrier does not have to be moved from the ensurer to the attacher.

The rotator 206 can comprise an electro-magnetic actuator 207 and rotating rolls 208. The electro-magnetic actuator 207 can be configured to attract the magnetically active element 115 and, therefore, to pull the sample container carrier 110 against the rotating rolls 208. The rotating rolls 208 can be configured to rotate the sample container carrier 110 and, therefore, the carried laboratory sample container 120.

Further, the laboratory automation system 10 can comprise a plurality of laboratory stations 20, 25. The laboratory sample distribution system 100 can be configured to distribute or to move the such as, for example, open, laboratory sample container 120 and/or the laboratory sample 130 and/or the sample container carrier 110 between the laboratory stations 20, 25.

The plurality of laboratory stations 20, 25 may comprise at least one pre-analytical, analytical and/or post-analytical station. In the shown embodiment, the laboratory stations 20, 25 can be arranged adjacent to the laboratory sample distribution system 100 and its transport plane 140, respectively. Self-evidently, more than the two laboratory stations 20, 25 depicted in FIG. 10 may be comprised in the laboratory automation system 10.

The plurality of laboratory stations 20, 25 can require the laboratory sample container 120 to be open for processing such as, for example, analyzing, the laboratory sample 130 comprised by the laboratory sample container 120.

The attached prolongation 190 can enable an access to the laboratory sample 130 comprised by the open laboratory sample container 120 for the plurality of laboratory stations 20, 25. In one embodiment, the attached prolongation 190 can enable taking the laboratory sample 130, or a part of the laboratory sample 130, out of the open laboratory sample container 120 and/or putting a reagent into the open laboratory sample container 120.

The laboratory apparatus 200, the ensurer 201, 202, the attacher 203, the optical reader 205, and/or the rotator 206 may be denoted as a laboratory station/s, as well.

Moreover, the laboratory apparatus 200 can comprise a sealer 210, as shown in FIG. 9, which may also be denoted as a laboratory station. The sealer 210 can be configured to close the opening 121 of the laboratory sample container 120 by sealing the attached prolongation 190.

The method can comprise closing the opening 121 of the laboratory sample container 120 by sealing the attached prolongation 190 such as, for example, by the sealer 210.

In detail, the prolongation 190 can be pressed together in FIG. 9 above the opening 121 by the sealer 210 and the prolongation 190 can be adhered to itself. In the shown embodiment, the prolongation 190 can comprise a hot sealable material and can be sealed by heat. The sealer 210 can be embodied as a heat sealer configured to seal the attached prolongation 190 by heat. In alternative embodiments, additionally, or alternatively, the prolongation may comprise an adhesive or an adhesive layer or an adhesive strip such as, for example, at an in FIG. 9 upper end of the prolongation. In other words, the prolongation blank, if present, may comprise the adhesive at its upper end or its lateral edge.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

I claim:

1. A method of handling a laboratory sample container, the method comprising:
a) ensuring that an opening of the laboratory sample container is open; and
b) attaching a prolongation to the laboratory sample container such that the prolongation surrounds the opening of the laboratory sample container and protrudes the opening and such that a laboratory sample comprised by the open laboratory sample container is retained by the attached prolongation.

2. The method according to claim 1, wherein the attached prolongation protrudes the opening by a length (L) of at least 1 mm to 20 mm.

3. The method according to claim 1, wherein the prolongation comprises a laboratory sample-repellent property.

4. The method according to claim 1, wherein step b) further comprises adhering the prolongation to the laboratory sample container.

5. The method according to claim 1, wherein step b) further comprises forming the prolongation by rotating a prolongation blank with respect to the laboratory sample container around the laboratory sample container.

6. The method according to claim 5, wherein the laboratory sample container comprises a from-the-outside optically readable tag.

7. The method according to claim 6, further comprises,
optically reading the tag during step b).

8. The method according to claim 1, further comprises,
c) moving the open laboratory sample container with the attached prolongation by a laboratory sample distribution system.

9. The method according to claim 8, wherein the laboratory sample distribution system comprises a sample container carrier, wherein the sample container carrier is configured to carry the laboratory sample container, a transport plane, wherein the transport plane is configured to support the sample container carrier, and a plurality of drive elements, wherein the plurality of drive elements is configured to move the sample container carrier.

10. The method according to claim 9, wherein step c) further comprises moving the sample container carrier with the carried laboratory sample container on the transport plane by the plurality of drive elements.

11. The method according to claim 9, wherein the plurality of drive elements comprises a plurality of electro-magnetic actuators, wherein the plurality of electro-magnetic actuators is stationary arranged in a grid below the transport plane and is configured to generate a magnetic field to move the sample container carrier on the transport plane, wherein the sample container carrier comprises a magnetically active element, and wherein the magnetically active element is configured to interact with the magnetic field generated by the plurality of electro-magnetic actuators such that a move force is applied to the sample container carrier.

12. The method according to claim 11, wherein step c) further comprises moving the sample container carrier by the plurality of electro-magnetic actuators.

13. The method according to claim 1, further comprises,
d) closing the opening of the laboratory sample container by sealing the attached prolongation.

14. A laboratory apparatus, the laboratory apparatus comprising:
an ensurer, wherein the ensurer is configured to ensure that an opening of a laboratory sample container is open; and
an attacher, wherein the attacher is configured to attach a prolongation to the laboratory sample container such that the prolongation surrounds the opening of the laboratory sample container and protrudes the opening, wherein the laboratory apparatus is configured such that a laboratory sample comprised by the open laboratory sample container is retained by the attached prolongation.

15. The laboratory apparatus according to claim 14, wherein the attacher is configured to supply a prolongation blank to the laboratory sample container such that the prolongation is formed by a rotation of the prolongation blank with respect to the laboratory sample container around the laboratory sample container.

16. The laboratory apparatus according to claim 14, further comprises,
an optical reader, wherein the optical reader is configured to optically read a from-the-outside optically readable tag comprised by the laboratory sample container during a rotation of the optical reader with respect to the laboratory sample container around the laboratory sample container.

17. A laboratory automation system, the laboratory automation system comprising:
a laboratory apparatus according to claim 14; and
a laboratory sample distribution system, wherein the laboratory sample distribution system is configured to move the open laboratory sample container with the attached prolongation.

18. The laboratory automation system according to claim 17, further comprises,
a plurality of laboratory stations, wherein the laboratory sample distribution system is configured to distribute the laboratory sample container and/or the laboratory sample between the laboratory stations.
